(19) United States
(12) Patent Application Publication
(10) Pub. No.: US 2013/0048012 A1
(43) Pub. Date: Feb. 28, 2013

(54) DENTAL FLOSS WITH OFFSET HEAD

(71) Applicant: Hsin-Chen Lin, Tainan (TW)

(72) Inventor: Hsin-Chen Lin, Tainan (TW)

(21) Appl. No.: 13/587,315

(22) Filed: Aug. 16, 2012

(30) Foreign Application Priority Data
Aug. 23, 2011 (TW) 100130097

(51) Int. Cl. A61C 15/04

(52) U.S. Cl. 132/323

(57) ABSTRACT

A dental floss includes a handle; a head including two parallel arms and a floss having both ends formed with open ends of the arms respectively; and an inclined element having one end formed with the handle and the other end formed with the head so that the head offsets with respect to the handle by a first distance in a first lateral direction. Further, each arm includes an inclined member formed with the head so that the arms offset with respect to the head by a second distance in the first lateral direction.

### BACKGROUND OF THE INVENTION

1. Field of the Invention

The invention relates to teeth cleaning devices and more particularly to a dental floss having an offset head for ensuring a thorough teeth cleaning.

2. Description of Related Art

Dental floss is made of, for example, a bundle of thin nylon filaments used to remove food and dental plaque from teeth. The floss is gently inserted between the teeth and scraped along the teeth sides, especially close to the gums.

A conventional F-shaped dental floss 1 is shown in FIGS. 1 and 2 and comprises a handle 11 and a head 12 including two parallel arms 121 and a floss 122 having both ends formed with open ends of the arms 121 respectively. As shown in FIG. 2, a person may insert the floss 122 between the teeth and exert a force to scrap the floss 122 along the teeth sides, thereby cleaning the teeth.

However, the conventional F-shaped dental floss 1 suffered from a couple of drawbacks. In detail, the person has to open his/her mouth wide and this is not comfortable. Further, both the hand and the handle 2 may contact the mouth in the teeth cleaning and in turn it may interfere with the cleaning. Thus, the need for improvement still exists.

### SUMMARY OF THE INVENTION

It is therefore one object of the invention to provide a dental floss comprising a handle; a head comprising two parallel arms and a floss having both ends formed with open ends of the arms respectively; and an inclined element having one end formed with the handle and the other end formed with the head so that the head offsets with respect to the handle by a first distance in a first lateral direction.

The above and other objects, features and advantages of the invention will become apparent from the following detailed description taken with the accompanying drawings.

### BRIEF DESCRIPTION OF THE DRAWINGS

FIG. 1 is a perspective view of a conventional dental floss;

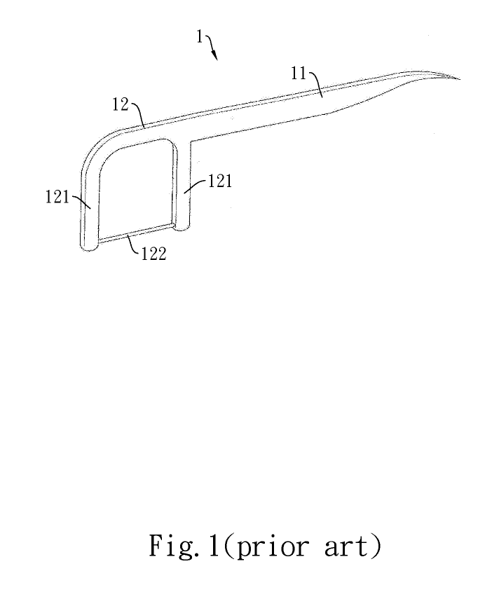

FIG. 2 is an environmental view showing the conventional dental floss being used to clean the teeth;

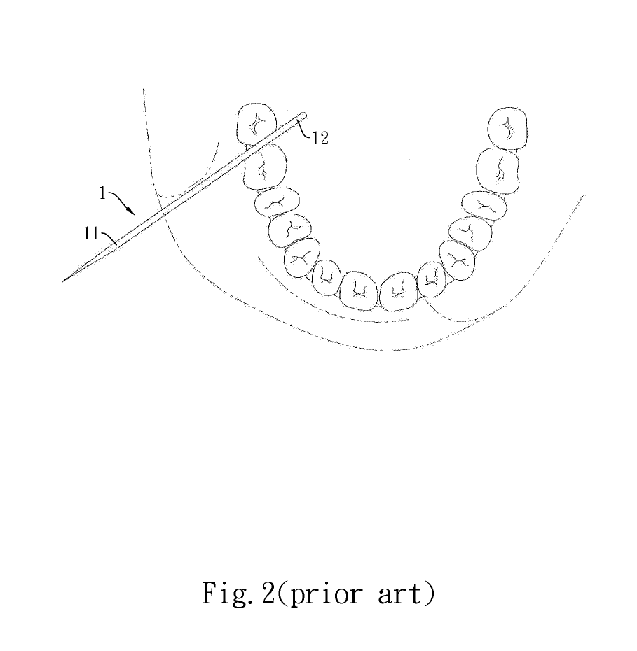

FIG. 3 is a perspective view of a dental floss according to a first preferred embodiment of the invention;

FIG. 4 is a top plan view of the dental floss shown in FIG. 3;

FIG. 5 is an environmental view showing the dental floss of FIG. 3 being used to clean the teeth;

FIG. 6 is another environmental view showing the dental floss of FIG. 3 being used to clean the teeth;

FIG. 7 is a perspective view of a dental floss according to a second preferred embodiment of the invention; and

FIG. 8 is a perspective view of a dental floss according to a third preferred embodiment of the invention.

### DETAILED DESCRIPTION OF THE INVENTION

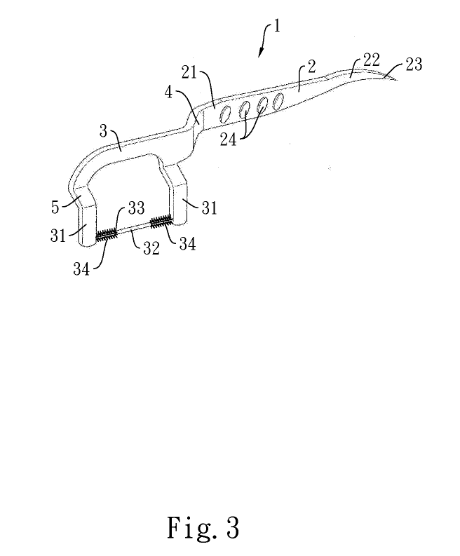

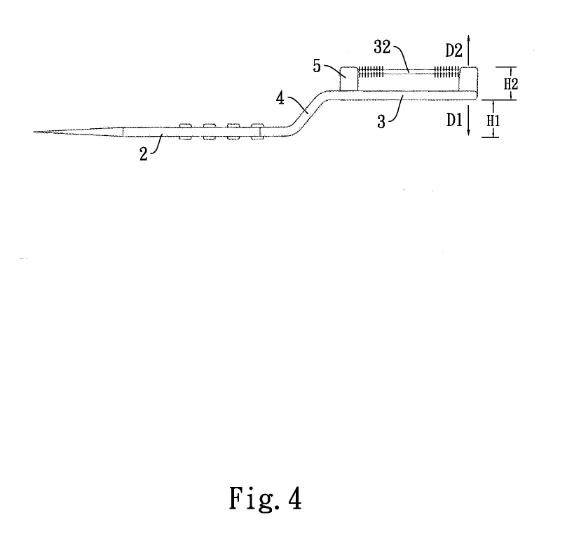

Referring to FIGS. 3 to 6, a dental floss 1 in accordance with a first preferred embodiment of the invention comprises the following components as discussed in detail below.

A flat handle 2 comprises a front end 21, a rear end 22, a sharp extension 23 projecting rearward out of the rear end 22, and a plurality of risers 24 on two opposite surfaces of the handle 2, i.e., the surfaces being knurled for allowing the hand (i.e., fingers) to get a better grip on the handle 2.

A head 3 comprises two parallel arms 31, a floss 32 having both ends formed with open ends of the arms 31 respectively, two sleeves 33 securely put on both ends of the floss 32 respectively, two units of a plurality of cleaning elements 34 fastened on the sleeves 33 respectively, and two inclined members 5 connecting the arms 31 to front and rear ends of the head 3 respectively so that the arms 31 offset with respect to the main body of the head 3 when viewing from top or bottom of the head 3 (i.e., by a distance H2 when viewing toward a direction D2).

An inclined element 4 has one end formed with a front end of the handle 2 and the other end formed with the rear end of the head 3. Thus, the handle 2 offsets with respect to the main body of the head 3 when viewing from top or bottom of the head 3 (i.e., by a distance H1 when viewing toward a direction D1).

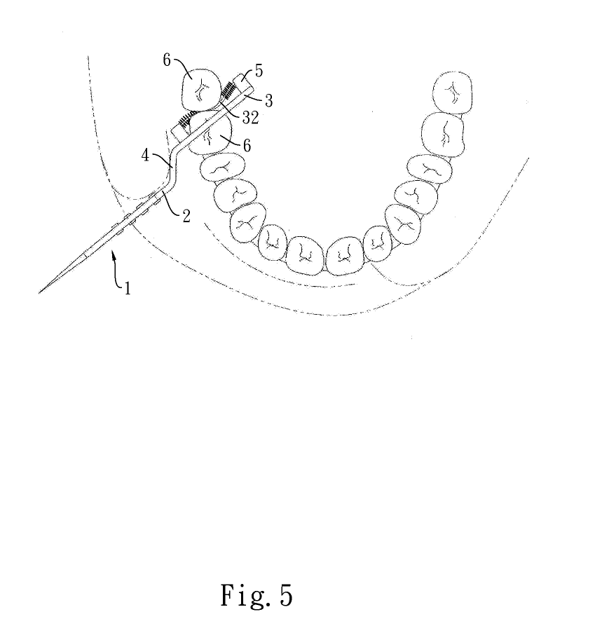

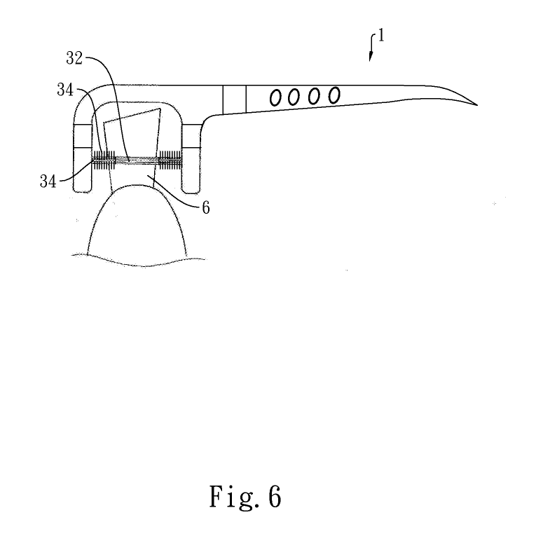

As shown in FIGS. 5 and 6, a person may insert the floss 32 between the teeth 6 and apply a force to scrap the floss 32 (i.e., the cleaning elements 34) along the teeth 6 sides, especially close to the gums, thereby cleaning the teeth 6. It is envisaged by the invention that the offset head 3 (i.e., the handle 2 offsets a distance H1 plus H2 with respect to the floss 32) can ensure a thorough cleaning by preventing the hand from being interfered by the teeth 6. Further, the cleaning can be made by requiring the person only open his/her mouth not wide open.

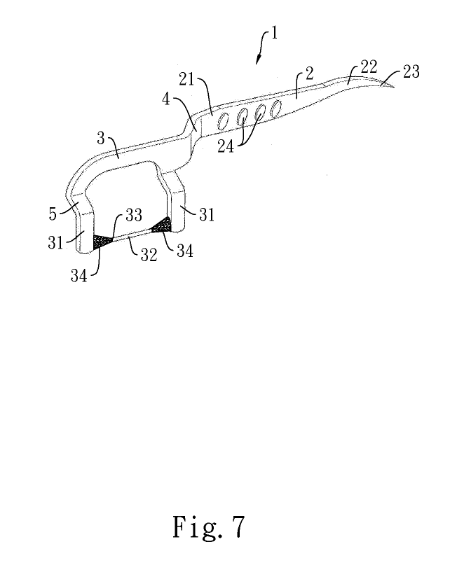

Referring to FIG. 7, a dental floss in accordance with a second preferred embodiment of the invention is shown. The characteristics of the second preferred embodiment are substantially the same as that of the first preferred embodiment except the following:

The cleaning elements 34 of the second preferred embodiment are implemented as thick cotton filaments or other filaments not harmful to the teeth rather than the cleaning elements 34 of the first preferred embodiment implemented as bristles.

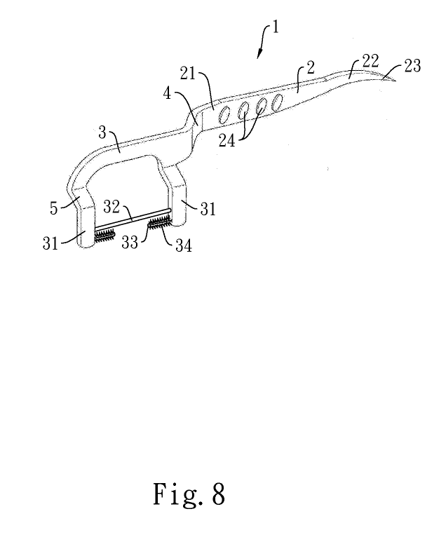

Referring to FIG. 8, a dental floss in accordance with a third preferred embodiment of the invention is shown. The characteristics of the third preferred embodiment are substantially the same as that of the first preferred embodiment except the following:

The head comprises two parallel arms 31, a floss 32 having both ends formed with open ends of the arms 31 respectively, and two sleeves 33 securely put on both ends of the floss 32 respectively, each sleeve 33 being formed with a plurality of cleaning elements around. The sleeves 33 are parallel to the floss 32 in close proximity.

While the invention has been described in terms of preferred embodiments, those skilled in the art will recognize that the invention can be practiced with modifications within the spirit and scope of the appended claims.

What is claimed is:

1. A dental floss comprising:
a handle;
a head comprising two parallel arms and a floss having both ends formed with open ends of the arms respectively; and
an inclined element having one end formed with the handle and the other end formed with the head so that the head offsets with respect to the handle by a first distance in a first lateral direction.

2. The dental floss of claim 1, wherein each arm comprises an inclined member formed with the head so that the arms offset with respect to the head by a second distance in the first lateral direction.

3. The dental floss of claim 1, wherein the head further comprises two sleeves securely put on both ends of the floss respectively, and two units of a plurality of cleaning elements fastened on the sleeves respectively.

4. The dental floss of claim 2, wherein the head further comprises two sleeves securely put on both ends of the floss respectively, and two units of a plurality of cleaning elements fastened on the sleeves respectively.

5. A dental floss comprising:
a handle;
a head comprising two parallel arms and a floss having both ends formed with open ends of the arms respectively; and
an inclined element having one end formed with the handle and the other end formed with the head so that the head offsets with respect to the handle by a first distance in a first lateral direction;
wherein each arm comprises an inclined member formed with the head so that the arms offset with respect to the head by a second distance in the first lateral direction.

6. The dental floss of claim 5, wherein the head further comprises two brush-like sleeves securely put on both ends of the floss respectively, the sleeves being parallel to the floss.
